(19) United States
(12) Patent Application Publication
(10) Pub. No.: US 2024/0333113 A1
(43) Pub. Date: Oct. 3, 2024

(54) MOTOR AND METHOD OF MANUFACTURING THE SAME

(71) Applicant: HL MANDO CORPORATION, Gyeonggi-do (KR)

(72) Inventors: Baikkee SONG, Gyeonggi-do (KR); Kiwon KANG, Gyeonggi-do (KR)

(21) Appl. No.: 18/622,965

(22) Filed: Mar. 31, 2024

(30) Foreign Application Priority Data
Mar. 31, 2023 (KR) 10-2023-0042501
Mar. 13, 2024 (KR) 10-2024-0035265

(51) Int. Cl. H02K 15/16; H02K 7/00

(52) U.S. Cl. CPC H02K 15/16; H02K 7/003

(57) ABSTRACT

In a motor including a stator and a rotor disposed to be spaced apart from an inner circumferential surface of the stator, the rotor may include a hollow shaft having a tubular shape and one end portion press-fitted into an inner ring of a bearing fixedly disposed in the motor and a screw shaft having one end portion inserted into a hollow portion provided in the one end portion of the hollow shaft, and an alignment part for axial alignment with the hollow shaft and a coupling part for preventing slippage on the hollow shaft may be provided on the one end portion of the screw shaft.

### CROSS-REFERENCE TO RELATED APPLICATION

This application claims the benefit of Korean Patent Application No. 10-2023-0042501, filed on Mar. 31, 2023 and Korean Patent Application No. 10-2024-0035265, filed on Mar. 13, 2024 in the Korean Intellectual Property Office, the disclosure of which is incorporated herein by reference.

### BACKGROUND

### 1. Field

Embodiments of the present disclosure relate to a motor and a method of manufacturing the same, and more specifically, to a hollow type motor in which only one end portion of a rotor is coupled to a bearing in the motor and thus the concentricity of the rotor is improved, and a method of manufacturing the same.

### 2. Description of the Related Art

Generally, brake systems for performing braking are necessarily mounted in vehicles, and recently, various types of electronic brake systems have been proposed for obtaining a stronger and more stable braking force. As an example, intelligent integrated dynamic brake (IDB) systems have been proposed. The IDB system is proposed to generate a stable and strong braking force by integrating a master booster and a vehicle electronic stability control (ESC) system.

In such an electronic brake system, a pedal displacement sensor outputs the movement of a pedal as an electrical signal to operate a motor, and the electronic brake system includes a hydraulic pressure supply device for converting a rotational force of the motor into a linear motion to generate braking hydraulic pressure, a modulator block in which a plurality of valves are installed to receive the hydraulic pressure and control a braking operation using a force generated by the hydraulic pressure supply device, and an electronic control unit for controlling the motor and the valves.

More specifically, in the integrated electronic brake system, the hydraulic pressure supply device operates according to the movement of a brake pedal to generate a braking pressure desired by a driver and transmits the hydraulic pressure to a wheel cylinder installed on each wheel. In this case, the hydraulic pressure supply device includes a motor, a pinion gear rotated by the motor, and a rack gear which moves linearly while engaged with the pinion gear. That is, in the hydraulic pressure supply device, the pinion gear is installed on a surface facing the rack gear to be engaged with the rack gear so that the rack gear can move linearly.

However, since the hydraulic pressure supply device provided with the above-described components is driven in a rack and pinion manner to generate braking pressure, there are problems of increasing the size of a rack gear driving device and excessively increasing weight. Therefore, there is a problem of degrading the mountability thereof in a vehicle and a lay-out design.

In order to solve the above problems, a hydraulic pressure supply device of an electronic brake system, which operates with a simple structure using a hollow type motor and a ball screw method, was proposed. However, in such a ball screw type motor, a screw shaft of a ball screw is coupled to a bearing at only one side of the motor.

Since the screw shaft is coupled to the bearing at only one side as described above, when the screw shaft is coupled in a manner of being tilted toward one side, a ball nut coupled to the screw shaft and a pump piston are in excessive contact with one side of an inner wall of a cylinder due to the movement of the ball nut, and thus the efficiency of a pump can be reduced, or noise or vibrations can occur. In addition, in severe cases, since the pump piston may become stuck in the cylinder, the concentricity of the screw shaft should be improved.

Meanwhile, such a screw shaft is coupled in the bearing with a hollow shaft that acts as a rotor of the motor, and knurling machining is performed on a coupling part to prevent slippage between the hollow shaft and the screw shaft. In the case of knurling machining, since it is difficult to accurately control sizes, and coupling is performed while the machined portion is deformed, it is difficult to improve the concentricity of the screw shaft.

### SUMMARY

Therefore, it is an aspect of the present disclosure to provide a motor, especially a hollow type motor in which only one end portion of a rotor is coupled to a bearing in the motor and thus the concentricity of the rotor is improved, and a method of manufacturing the same.

In accordance with one aspect of the present disclosure, a motor including a stator and a rotor disposed to be spaced apart from an inner circumferential surface of the stator includes a hollow shaft having a tubular shape and one end portion press-fitted into an inner ring of a bearing fixedly disposed in the motor and a screw shaft having one end portion inserted into a hollow portion provided in the one end portion of the hollow shaft, and an alignment part for axial alignment with the hollow shaft and a coupling part for preventing slippage on the hollow shaft are provided on the one end portion of the screw shaft.

The alignment part may be slidably coupled to the hollow portion of the hollow shaft.

The alignment part may be press-fitted into the hollow portion of the hollow shaft.

The coupling part may be knurled and coupled to the hollow shaft.

The alignment part may be located closer to an end portion than the coupling part.

An outer diameter of the alignment part may be smaller than an outer diameter of the coupling part.

A fixing part protruding through the hollow portion and the inner ring of the bearing and coupled to a fixing member configured to prevent the screw shaft from being separated from the bearing may be provided on the one end portion of the screw shaft.

An outer diameter of the fixing part may be smaller than the outer diameter of the alignment part.

The hollow portion may include a small diameter portion in contact with the alignment part and a large diameter portion having an inner diameter greater than an inner diameter of the small diameter portion and coupled to the coupling part, wherein the small diameter portion may be located closer to the end portion than the large diameter portion.

An inner diameter of the large diameter portion may be smaller than an outer diameter of the coupling part.

In the one end portion of the hollow shaft, an outer diameter of an outer circumferential surface of a portion coupled to the coupling part may be smaller than an outer diameter of an outer circumferential surface of a portion coupled to the alignment part.

A distance from a lower end portion of the alignment part to a lower end portion of the coupling part may be greater than an axial length of the large diameter portion.

At least one keyway may be provided in the one end portion of the hollow shaft.

A concave portion recessed toward a rotation axis along an outer circumferential surface of the screw shaft may be provided between the alignment part and the coupling part.

The hollow shaft may be made of a material whose hardness is lower than that of the bearing.

An axial length of the alignment part may be greater than an axial length of the coupling part.

In accordance with another aspect of the present disclosure, a method of manufacturing a motor including a stator and a rotor disposed to be spaced apart from an inner circumferential surface of the stator is provided, the method including arranging a bearing in the motor, press-fitting one end portion of a hollow shaft having a tubular shape into an inner ring of the bearing, and inserting one end portion of a screw shaft into a hollow portion provided in the one end portion of the hollow shaft, wherein the inserting of the one end portion of the screw shaft includes inserting an alignment part provided on the one end portion of the screw shaft for axial alignment with the hollow shaft into the hollow portion and inserting a coupling part provided on the one end portion of the screw shaft for preventing slippage on the hollow shaft into the hollow portion.

The inserting of the alignment part may include slidably coupling the alignment part into the hollow portion.

The inserting of the alignment part may include press-fitting the alignment part into the hollow portion.

The method of manufacturing the motor further includes coupling a fixing member configured to prevent the screw shaft from being separated from the bearing to a fixing part protruding through the hollow portion and the inner ring of the bearing.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematic exploded perspective view illustrating a motor according to the present embodiment;

FIG. 2 is a schematic perspective cross-sectional view illustrating a coupling structure of a rotor and a bearing of the motor according to the present embodiment;

FIG. 3 is a schematic cross-sectional view illustrating one end portion of a hollow shaft of the rotor according to the present embodiment;

FIG. 4 is a schematic cross-sectional view illustrating one end portion of a screw shaft of the rotor according to the present embodiment;

FIG. 5 is a schematic cross-sectional view illustrating the coupling structure of the rotor and the bearing of the motor according to the present embodiment;

FIG. 6 is a schematic cross-sectional view illustrating how the rotor of the motor according to the present embodiment is coupled;

FIG. 7 is a schematic partial cross-sectional view illustrating a state in which the rotor of the motor according to the present embodiment is coupled;

FIG. 8 is a schematic cross-sectional view illustrating one end portion of a screw shaft of a rotor according to another embodiment;

FIG. 9 is a schematic cross-sectional view illustrating a coupling structure of the rotor and a bearing of a motor according to another embodiment; and

FIG. 10 is a schematic flowchart illustrating a method of manufacturing a motor according to the present embodiment.

### DETAILED DESCRIPTION

Hereinafter, embodiments of the present disclosure will be described in detail with reference to the accompanying drawings. The following embodiments are provided to sufficiently convey the spirit of the present disclosure to those skilled in the art. The present disclosure is not limited to the embodiments disclosed herein and may be implemented in different forms. In the drawings, portions which are not related to the description may be omitted to clarify the present disclosure, and the sizes of components may be exaggerated to facilitate understanding of the present disclosure.

Hereinafter, the operating principle and embodiments of the present disclosure will be described with reference to the accompanying drawings.

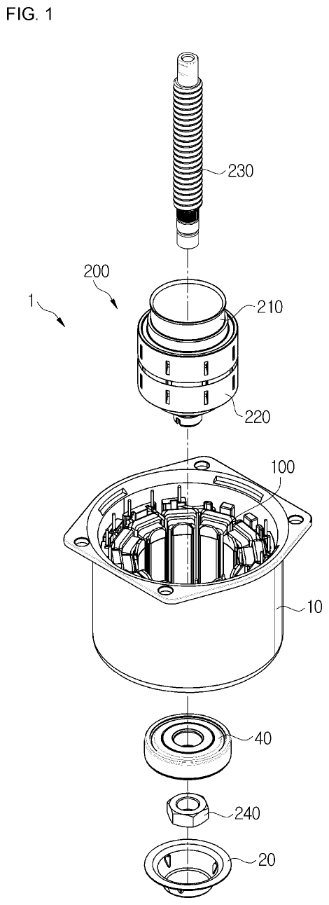

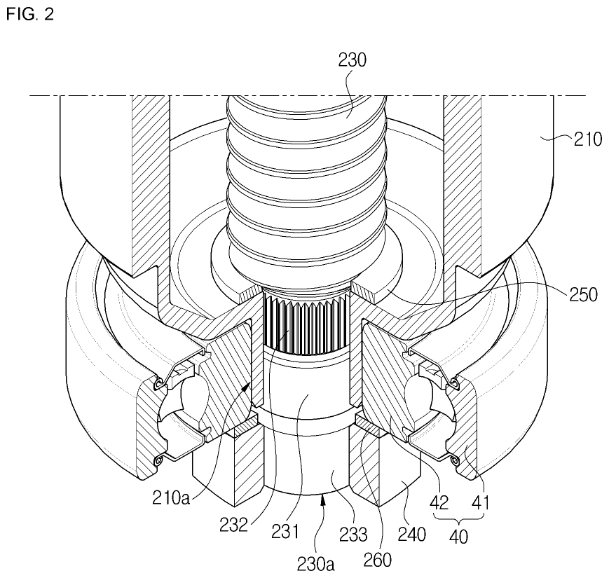

FIG. 1 is a schematic exploded perspective view illustrating a motor according to the present embodiment, and FIG. 2 is a schematic perspective cross-sectional view illustrating a coupling structure of a rotor and a bearing of the motor according to the present embodiment.

A motor 1 according to the present embodiment may transmit a driving force to a hydraulic pressure supply device of an electronic brake system. The hydraulic pressure supply device operates by receiving an electrical signal as the braking intention of a driver from a pedal displacement sensor which detects the displacement of a brake pedal and provides oil pressure transferred to a wheel cylinder of the electronic brake system. The hydraulic pressure supply device may be provided with various components. As an example, a piston moved by the driving force of the motor 1 may push oil in a chamber out to transfer hydraulic pressure to the wheel cylinder.

In this case, the piston is connected to the motor 1 using a ball screw method so that the oil in the chamber may be pushed out according to the driving of the motor 1.

Referring to FIGS. 1 and 2, the configuration of the motor 1 according to the present embodiment having the ball screw method can be seen.

The motor 1 may include a stator 100 and a rotor 200 disposed to be spaced apart from an inner circumferential surface of the stator 100. The motor 1 may be coupled to a modulator block (not shown) in which a flow path and a valve for adjusting braking hydraulic pressure are provided.

When power is supplied, the motor 1 generates a rotational force. The motor 1 includes the stator 100 which receives power to generate an electric field and the rotor 200 which rotates by changes in the electric field, and the rotor 200 is disposed inside and spaced apart from the stator 100. Magnets 220 for generating a rotational force may be provided on the rotor 200, the plurality of magnets 220 are installed on an outer surface of the rotor 200, and a gap may be formed between the magnets 220 and the stator 100 so that the rotor 200 rotates without interference.

In the present embodiment, the motor 1 may be a hollow type motor. The rotor 200 of the hollow type motor may include a hollow shaft 210 having a tubular shape. The plurality of magnets 220 may be installed on an outer circumferential surface of the hollow shaft 210.

A screw shaft 230 of a ball screw may be disposed in a hollow portion 211 provided in a one end portion 210a of the hollow shaft 210. The screw shaft 230 may be coupled to the hollow shaft 210 and may rotate along with the hollow shaft 210. A one end portion 230a of the screw shaft 230 may be coupled to the one end portion 210a of the hollow shaft 210 to rotate along therewith, and a ball nut (not shown) may be disposed between and coupled to the screw shaft 230 and the hollow shaft 210 in a radial direction of rotation and move forward and backward according to rotation of the screw shaft 230.

The motor 1 according to the present embodiment including the stator 100 and the rotor 200 as described above may include a housing 10 in which the stator 100 and the rotor 200 are accommodated and an opening centered on a rotation axis and exposing at least a portion of the rotor 200 to the outside is provided, a bearing 40 coupled to at least a portion of the rotor 200 and fixedly disposed in the housing 10, and a cover member 20 covering the opening of the housing 10.

The bearing 40 may be provided between the housing 10 and the rotor 200. The bearing 40 may be interposed between the housing 10 and the rotor 200 and rotatably support the rotor 200.

The bearing 40 may include an outer ring 41 in fixed contact with the housing 10 and an inner ring 42 disposed inside the outer ring 41 and in fixed contact with the rotor 200. A structure such as a ball or roller for reducing friction may be provided between the outer ring 41 and the inner ring 42 so that the inner ring 42 easily rotates with respect to the outer ring 41.

At least a portion of the rotor 200 is coupled to the inner ring 42 of the bearing 40 through the opening of the housing 10. In the present embodiment, the one end portion 210a of the hollow shaft 210 of the rotor 200 and the one end portion 230a of the screw shaft 230 may be coupled to the inner ring 42 of the bearing 40.

In the present embodiment, the one end portion 210a of the hollow shaft 210 may be press-fitted into the inner ring 42 of the bearing 40, and the one end portion 230a of the screw shaft 230 may be inserted into the hollow portion 211 provided in the one end portion 210a of the hollow shaft 210.

A washer 250 may be disposed between the screw shaft 230 and the hollow shaft 210.

The other end portion of the hollow shaft 210 may be supported by another bearing (not shown). Both end portions of the hollow shaft 210 may be supported by the bearings and stably fixed in the housing 10 of the motor 1 so that the hollow shaft 210 may rotate around the rotation axis.

Conversely, the one end portion 230a of the screw shaft 230 is coupled to the bearing 40, and the other end portion thereof is not supported by a bearing. Accordingly, when both the hollow shaft 210 and screw shaft 230 rotate, in a case in which the concentricity between the screw shaft 230 and the hollow shaft 210 is low, the screw shaft 230 may vibrate as it rotates, and the efficiency of a ball nut (not shown) and a piston (not shown) which are coupled to the screw shaft 230 and move forward and backward may be reduced.

In the present embodiment, an alignment part 231 may be provided on the screw shaft 230 in order to increase the concentricity between the screw shaft 230 and the hollow shaft 210.

The alignment part 231 for axial alignment with the hollow shaft 210, a coupling part 232 for preventing slippage on the hollow shaft 210, and a fixing part 233 protruding through the hollow portion 211 of the hollow shaft 210 and the inner ring 42 of the bearing 40 and coupled to a fixing member 240, which prevents the screw shaft 230 from being separated from the bearing 40, may be provided on the one end portion 230a of the screw shaft 230 according to the present embodiment.

As illustrated in FIG. 2, the alignment part 231 may be located closer to the end portion than the coupling part 232. Accordingly, when the one end portion 230a of the screw shaft 230 is coupled to the hollow shaft 210 from the inside toward the outside thereof, the alignment part 231 is inserted into the hollow portion 211 of the hollow shaft 210 first, and then the coupling part 232 is inserted into the hollow portion 211.

The alignment part 231 guides an axial direction of the screw shaft 230 to be aligned with an axial direction of the hollow shaft 210 when the coupling part 232 is inserted into the hollow portion 211 provided in the one end portion 210a of the hollow shaft 210.

In the present embodiment, the alignment part 231 may be slidably coupled to the hollow portion 211 of the hollow shaft 210. As the alignment part 231 is slidably coupled to the hollow portion 211 and an outer circumferential surface of the alignment part 231 comes into contact with an inner circumferential surface of the hollow portion 211, the axial direction of the screw shaft 230 may be aligned with the axial direction of the hollow shaft 210.

Alternatively, in another embodiment, an alignment part 231 may be press-fitted into the hollow portion 211 of the hollow shaft 210. When the alignment part 231 is press-fitted into the hollow portion 211, in a case in which an axial direction of a screw shaft 230 is not aligned with an axial direction of the hollow shaft 210, the press fitting is not easily performed. Accordingly, in a process of press-fitting the alignment part 231, the axial direction of the screw shaft 230 may be aligned with the axial direction of the hollow shaft 210.

The coupling part 232 is provided so that the hollow shaft 210 and the screw shaft 230 are coupled to rotate together without slipping when the motor 1 rotates. Particularly, the coupling part 232 is provided to prevent the hollow shaft 210 and the screw shaft 230 from slipping and spinning even due to a torque generated due to a load applied to the screw shaft 230.

In the present embodiment, knurling machining may be performed on the coupling part 232, and the coupling part 232 may be coupled to the hollow shaft 210. In FIG. 2, although the coupling part 232 which is linearly knurled is illustrated, the present disclosure is not limited thereto, and the present disclosure may include a coupling part 232 which is knurled in a different manner.

The knurled coupling part 232 of the screw shaft 230 may be press-fitted into the hollow portion 211 of the hollow shaft 210. As the coupling part 232 knurled as described above is press-fitted into the hollow portion 211, the hollow shaft 210 and the screw shaft 230 may rotate together without spinning even when torque is applied.

In the present embodiment, the hollow shaft 210 may be made of a material whose hardness is lower than that of the bearing 40. As the hollow shaft 210 is made of a material whose hardness is lower than that of the bearing 40, when the alignment part 231 and/or the coupling part 232 of the screw shaft 230 is press-fitted into the hollow portion 211, the hollow shaft 210 is deformed, and thus the hollow shaft 210 and the screw shaft 230 may be firmly coupled.

As the alignment part 231 may be located closer to the end portion than the coupling part 232 as described above, the axial direction of the screw shaft 230 may be aligned with the axial direction of the hollow shaft 210 by the alignment part 231 before the coupling part 232 is inserted into the hollow shaft 210. Accordingly, in the present embodiment, after the axial direction of the screw shaft 230 is aligned by the alignment part 231, the screw shaft 230 is firmly coupled to the hollow shaft 210 by the coupling part 232, and thus the concentricity of the screw shaft 230 can be increased.

The fixing part 233 may be provided on the one end portion 230a of the screw shaft 230, pass through the hollow portion 211 of the hollow shaft 210 and the inner ring 42 of the bearing 40, and be coupled to the fixing member 240. As an example, the fixing member 240 may be provided as a nut, a thread may be provided on the fixing part 233 provided on the one end portion 230a of the screw shaft 230, and the fixing part 233 may be screw-coupled to the fixing member 240.

A washer 260 may be disposed between the fixing member 240 and the inner ring 42 of the bearing 40. In the present embodiment, the washer 260 may be provided as a spring washer to allow the fixing member 240 to be firmly coupled to the fixing part 233.

Hereinafter, a coupling structure of the hollow shaft 210, the screw shaft 230, and the bearing will be described in more detail.

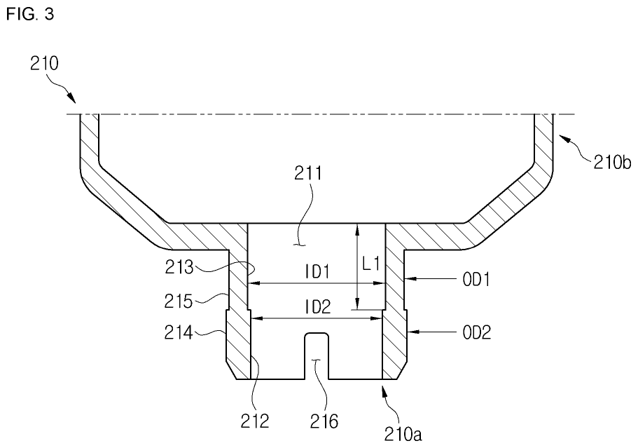

FIG. 3 is a schematic cross-sectional view illustrating one end portion of the hollow shaft of the rotor according to the present embodiment.

Referring to FIG. 3, the one end portion 210a of the hollow shaft 210 of the rotor 200 according to the present embodiment may have a diameter smaller than that of a body 210b coupled to the magnets 220 in order to be coupled to the inner ring 42 of the bearing 40.

The hollow portion 211 may be provided in the one end portion 210a of the hollow shaft 210, and the screw shaft 230 may be inserted into and coupled to the hollow portion 211.

In the embodiment of the present disclosure, the hollow portion 211 may include a small diameter portion 212 in contact with the alignment part 231 of the screw shaft 230 and a large diameter portion 213 which has an inner diameter ID1 greater than an inner diameter ID2 of the small diameter portion 212 and is coupled to the coupling part 232 of the screw shaft 230.

The small diameter portion 212 is in contact with the alignment part 231 of the screw shaft 230. When the alignment part 231 of the screw shaft 230 is inserted into the hollow portion 211 of the hollow shaft 210, as the alignment part 231 of the screw shaft 230 comes into contact with the small diameter portion 212, the axial direction of the screw shaft 230 may be aligned with the axial direction of the hollow shaft 210.

The small diameter portion 212 may be located closer to the end portion of the hollow shaft 210 than the large diameter portion 213. That is, as illustrated in FIG. 3, the small diameter portion 212 may be disposed under the large diameter portion 213.

Since the small diameter portion 212 is disposed closer to the end portion of the hollow shaft 210 than the large diameter portion 213 as described above, when the alignment part 231 of the screw shaft 230 is inserted into the hollow portion 211, in the large diameter portion 213 having the greater inner diameter ID1, the outer circumferential surface of the alignment part 231 may pass through the inner circumferential surface of the large diameter portion 213 without coming into contact therewith, and thus the alignment part 231 may be inserted into the hollow portion 211. In addition, in the small diameter portion 212 having the smaller inner diameter ID2, the outer circumferential surface of the alignment part 231 may come into contact with an inner circumferential surface of the small diameter portion 212 to align the axial direction of the screw shaft 230.

The inner diameter ID1 of the large diameter portion 213 may be greater than an outer diameter OD4 of the alignment part 231. Since the inner diameter ID1 of the large diameter portion 213 is greater than the outer diameter OD4 of the alignment part 231, the alignment part 231 may be inserted by passing through the large diameter portion 213 and coupled to the small diameter portion 212.

Meanwhile, the inner diameter ID1 of the large diameter portion 213 may be smaller than an outer diameter OD3 of the coupling part 232. An outer circumferential surface of the coupling part 232 according to the present embodiment may be knurled, and the knurled coupling part 232 may be press-fitted into the large diameter portion 213. Accordingly, since the inner diameter ID1 of the large diameter portion 213 is smaller than the outer diameter OD3 of the coupling part 232, the coupling part 232 may come into contact with and may be press-fitted into the inner circumferential surface of the large diameter portion 213.

Meanwhile, in the one end portion 210a of the hollow shaft 210 according to the present embodiment, an outer diameter OD1 of an outer circumferential surface 215 of a portion coupled to the coupling part 232 may be smaller than an outer diameter OD2 of an outer circumferential surface 214 of a portion coupled to the alignment part 231.

The one end portion 210a of the hollow shaft 210 is fixedly inserted into the inner ring 42 of the bearing 40. Preferably, the one end portion 210a of the hollow shaft 210 is press-fitted into the inner ring 42 of the bearing 40.

Accordingly, an outer diameter of the hollow shaft 210 has a size corresponding to an inner diameter of the inner ring 42 of the bearing 40. Preferably, the outer diameter OD2 of the outer circumferential surface 214 of the portion coupled to the alignment part 231 of the one end portion 210a of the hollow shaft 210 may be the same as the inner diameter of the inner ring 42 of the bearing 40 in a predetermined tolerance range so that the hollow shaft 210 may be press-fitted into the inner ring 42.

Meanwhile, the outer diameter OD1 of the outer circumferential surface 215 of the portion coupled to the coupling part 232 may be smaller than the outer diameter OD2 of the outer circumferential surface 214 of the portion coupled to the alignment part 231 to prevent damage to the hollow shaft 210 when deformation occurs due to the coupling of the coupling part 232. Such a configuration will be described below.

At least one keyway 216 may be provided in the one end portion 210a of the hollow shaft 210 according to the present embodiment. Preferably, a pair of keyways 216 may be provided in the one end portion 210a of the hollow shaft 210 in different directions, that is, at positions spaced 180° from each other around the rotation axis in a circumferential direction of the one end portion 210a.

The keyways 216 may be provided to hold and fix the hollow shaft 210 using a tool or the like in a process of manufacturing the motor 1, and when the alignment part 231 of the screw shaft 230 is press-fitted into the hollow portion 211 of the hollow shaft 210, the keyway 216 may provide a space in which the one end portion 210a of the hollow shaft 210 may be deformed by press fitting to prevent damage to the hollow shaft 210. This will be described below.

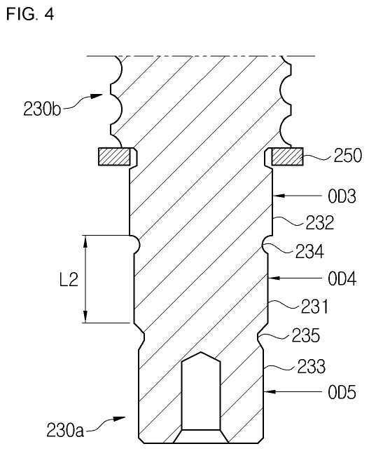

FIG. 4 is a schematic cross-sectional view illustrating one end portion of the screw shaft of the rotor according to the present embodiment.

Referring to FIG. 4, the fixing part 233, the alignment part 231, and the coupling part 232 may be sequentially provided from an end portion side (lower side of FIG. 4) of the one end portion 230a of the screw shaft 230 according to the present embodiment.

The fixing part 233 may protrude through the hollow portion 211 of the hollow shaft 210 and the inner ring 42 of the bearing 40 and may be coupled to the fixing member 240. In the present embodiment, a thread may be formed on the fixing part 233, the fixing member 240 may be provided as a nut, and thus the fixing part 233 and the fixing member 240 may be coupled.

The alignment part 231 may come into contact with the inner circumferential surface of the hollow portion 211 of the hollow shaft 210, specifically, the small diameter portion 212, so that the screw shaft 230 is axially aligned with the hollow shaft 210.

The coupling part 232 may be in contact with the inner circumferential surface of the hollow portion 211 of the hollow shaft 210, specifically, the large diameter portion 213, to prevent slippage between the screw shaft 230 and the hollow shaft 210.

A screw may be provided on a body 230b of the screw shaft 230. In the present embodiment, the body 230b of the screw shaft 230 may have an outer diameter greater than that of the one end portion 230a, and a washer 250 in contact with the hollow shaft 210 may be disposed on a stepped portion formed due to a difference in outer diameter between the body 230b and the one end portion 230a.

The outer diameter OD4 of the alignment part 231 according to the present embodiment may be smaller than the outer diameter OD3 of the coupling part 232.

As described above, the one end portion 230a of the screw shaft 230 is inserted into the hollow portion 211 in a direction from the inside toward the outside of the body 210b of the hollow shaft 210. Accordingly, the alignment part 231 which is closer to an end portion side of the screw shaft 230 is inserted into the hollow portion 211 before the coupling part 232. In this case, the alignment part 231 with the smaller outer diameter OD4 may be inserted by passing through the large diameter portion 213 of the hollow portion 211, and the coupling part 232 with the larger outer diameter OD3 may come into contact with and may be coupled to the inner circumferential surface of the large diameter portion 213.

Meanwhile, an outer diameter OD5 of the fixing part 233 according to the present embodiment may be smaller than the outer diameter OD4 of the alignment part 231.

As described above, when the one end portion 230a of the screw shaft 230 is inserted into the hollow portion 211 in the direction from the inside toward the outside of the body 210b of the hollow shaft 210, since the outer diameter OD5 of the fixing part 233 is smaller than the outer diameter OD4 of the alignment part 231, the one end portion 230a of the screw shaft 230 may be inserted by passing through both the large diameter portion 213 and the small diameter portion 212 of the hollow portion 211. That is, the fixing part 233 may pass through both the hollow portion 211 of the hollow shaft 210 and the inner ring 42 of the bearing 40 and may be coupled to the fixing member 240.

Concave portions 234 and 235 recessed toward the rotation axis may be provided along an outer circumferential surface of the screw shaft 230 between the alignment part 231 and the coupling part 232 and between the alignment part 231 and the fixing part 233 provided on the one end portion 230a of the screw shaft 230 according to the present embodiment.

The concave portions 234 and 235 may be provided to distinguish the alignment part 231 and the coupling part 232 and distinguish the alignment part 231 and the fixing part 233 from each other, respectively.

The alignment part 231, the coupling part 232, and the fixing part 233 according to the present embodiment may be formed by machining an outer circumferential surface of the one end portion 230a of the screw shaft 230. In this case, outer circumferential surfaces of the alignment part 231, the coupling part 232, and the fixing part 233 may be machined in different ways. For example, the outer circumferential surface of the alignment part 231 may be machined in a cylindrical shape for press fitting or slide coupling, the outer circumferential surface of the coupling part 232 may be knurled, and a thread may be formed on the outer circumferential surface of the fixing part 233 for coupling to the fixing member 240.

As described above, the concave portions 234 and 235 may be provided to distinguish the alignment part 231, the coupling part 232, and the fixing part 233 which are individually machined as described above to allow the outer circumferential surfaces of the alignment part 231, the coupling part 232, and the fixing part 233 to be easily machined.

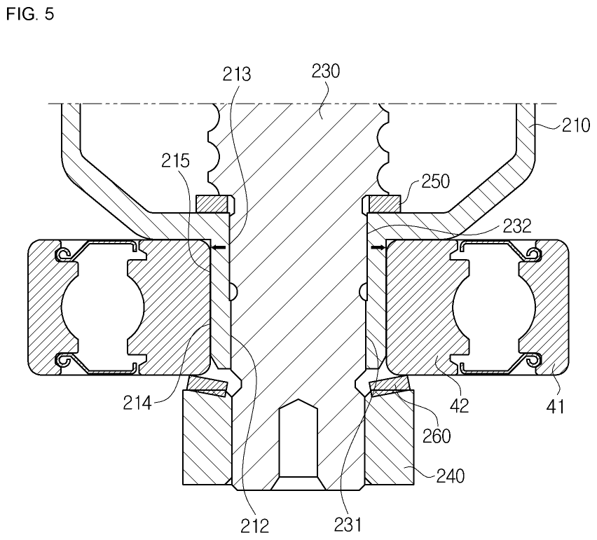

FIG. 5 is a schematic cross-sectional view illustrating the coupling structure of the rotor and the bearing of the motor according to the present embodiment.

Referring to FIG. 5, the hollow shaft 210 and the screw shaft 230 of the motor 1 according to the present embodiment may be inserted into and fixedly coupled to the inner ring 42 of the bearing 40.

As described above, the one end portion 230a of the screw shaft 230 may be inserted into and coupled to the hollow portion 211 provided in the one end portion 210a of the hollow shaft 210, and the alignment part 231 and the coupling part 232 of the screw shaft 230 may be coupled to the small diameter portion 212 and the large diameter portion 213 of the hollow portion 211, respectively.

Meanwhile, the coupling part 232 according to the present embodiment may be knurled and coupled to the large diameter portion 213 of the hollow shaft 210. The knurled coupling part 232 may be press-fitted into the large diameter portion 213 to prevent the screw shaft 230 from slipping on the hollow shaft 210.

In this case, when the coupling part 232 is press-fitted into the large diameter portion 213, since the one end portion 210a in which the large diameter portion 213 of the hollow shaft 210 is provided is press-fitted into the inner ring 42 of the bearing 40, the one end portion 210a receives a heavy load between the inner ring 42 and the coupling part 232. When such a load is applied, since stress is concentrated on the one end portion 210a of the hollow shaft 210, the hollow shaft 210 may be damaged.

In the one end portion 210a of the hollow shaft 210 according to the present embodiment, the outer diameter OD1 of the outer circumferential surface 215 of the portion coupled to the coupling part 232 may be smaller than the outer diameter OD2 of the outer circumferential surface 214 of the portion coupled to the alignment part 231. Accordingly, when the one end portion 210a of the hollow shaft 210 is press-fitted into the inner ring 42 of the bearing 40, the outer circumferential surface 215 of the portion coupled to the coupling part 232 may be spaced apart from the inner ring 42 of the bearing 40. Then, when the screw shaft 230 is inserted into the hollow portion 211 and coupled to the coupling part 232, as indicated by an arrow in FIG. 5, the one end portion 210a of the hollow shaft 210 is deformed into a space spaced apart from the inner ring 42 to disperse stress and prevent damage to the hollow shaft 210.

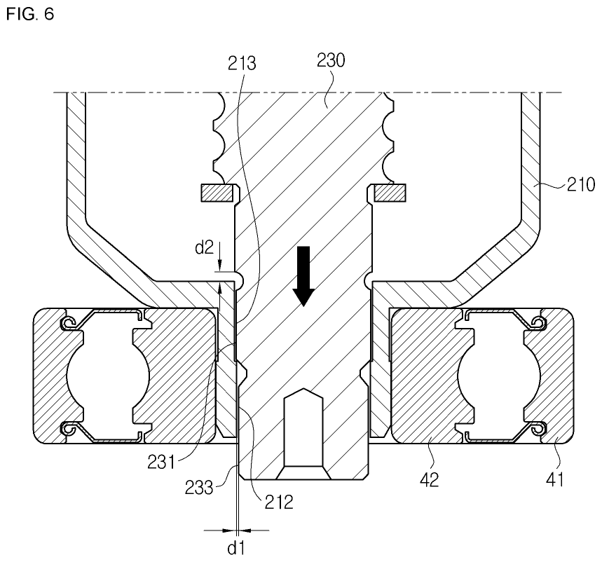

FIG. 6 is a schematic cross-sectional view illustrating how the rotor of the motor according to the present embodiment is coupled.

Referring to FIG. 6, a process in which the one end portion 230a of the screw shaft 230 is inserted into the hollow portion 211 of the hollow shaft 210 is illustrated.

As described above, the outer diameter OD5 of the fixing part 233 located closer to an end portion side than the alignment part 231 may be smaller than the outer diameter OD4 of the alignment part 231. Accordingly, the fixing part 233 may be inserted into the hollow portion 211 of the hollow shaft 210 through the inner circumferential surfaces of the large diameter portion 213 and the small diameter portion 212 without coming into contact therewith. As illustrated in the drawing, the fixing part 233 may be inserted at a predetermined distance d1 from the small diameter portion 212 of the hollow portion 211.

Meanwhile, in the present embodiment, a distance L2 from a lower end portion of the alignment part 231 to a lower end portion of the coupling part 232 indicated in FIG. 4 may be greater than an axial length L1 of the large diameter portion 213 indicated in FIG. 3.

As illustrated with an arrow in FIG. 6, the one end portion 230a of the screw shaft 230 is coupled to the hollow shaft 210 from the inside toward the outside thereof. In this case, as illustrated in FIG. 6, when the lower end portion of the alignment part 231 comes into contact with an upper end portion of the small diameter portion 212 and the alignment part 231 and the small diameter portion 212 are coupled, since the distance L2 from the lower end portion of the alignment part 231 to the lower end portion of the coupling part 232 is greater than the axial length L1 of the large diameter portion 213, the lower end portion of the coupling part 232 is spaced a predetermined distance d2 from the large diameter portion 213 without being coupled thereto. Then, when the one end portion 230a of the screw shaft 230 is inserted deeper into the hollow portion 211, the coupling part 232 and the large diameter portion 213 are coupled.

That is, in an initial stage in which the alignment part 231 and the small diameter portion 212 are coupled, since the coupling part 232 and the large diameter portion 213 are not coupled, the axial alignment of the screw shaft 230 is achieved by contact between the alignment part 231 and the small diameter portion 212, and after the axial alignment is achieved, the coupling part 232 and the large diameter portion 213 may be coupled to fix the screw shaft 230 and the hollow shaft 210 so that the screw shaft 230 and the hollow shaft 210 do not slip.

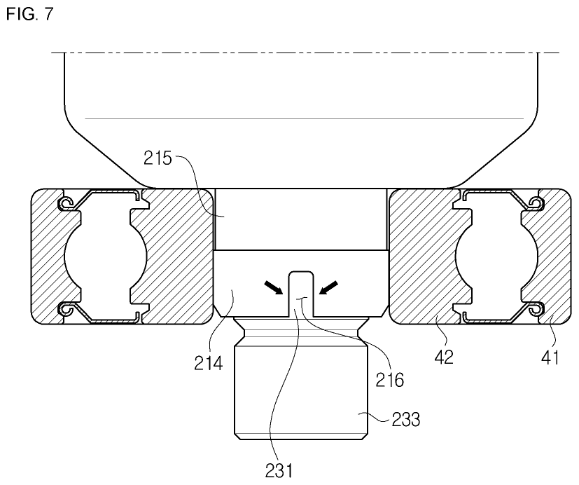

FIG. 7 is a schematic partial cross-sectional view illustrating a state in which the rotor of the motor according to the present embodiment is coupled.

As illustrated in FIG. 7, at least one keyway 216 may be provided in the one end portion 210a of the hollow shaft 210. The keyway 216 may be provided to hold and fix the hollow shaft 210 using a tool or the like in the process of manufacturing the motor 1.

In addition, when the alignment part 231 of the screw shaft 230 is press-fitted into the hollow portion 211 of the hollow shaft 210, specifically, the small diameter portion 212, the keyway 216 may provide a space in which the one end portion 210a of the hollow shaft 210 may be deformed by press fitting.

When the alignment part 231 is press-fitted into the small diameter portion 212 of the hollow shaft 210, the one end portion 210a in which the small diameter portion 212 of the hollow shaft 210 is provided is press-fitted into the inner ring 42 of the bearing 40 and receives a heavy load between the inner ring 42 and the alignment part 231. When such a load is applied, stress is concentrated on the one end portion 210a of the hollow shaft 210, and the hollow shaft 210 may be damaged.

Since at least one keyway 216 is provided in the one end portion 210a of the hollow shaft 210 according to the present embodiment, when the alignment part 231 is press-fitted into the small diameter portion 212 of the hollow shaft 210, as indicated by an arrow in FIG. 7, the one end portion 210a of the hollow shaft 210 is deformed toward keyway 216 to disperse stress and prevent damage to the hollow shaft 210.

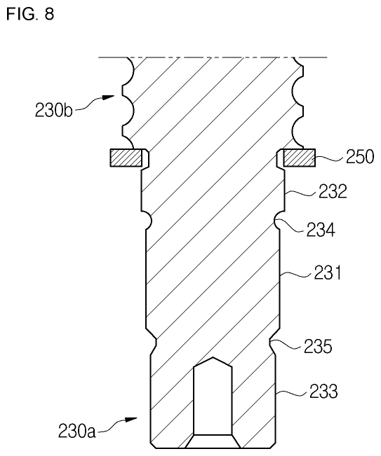

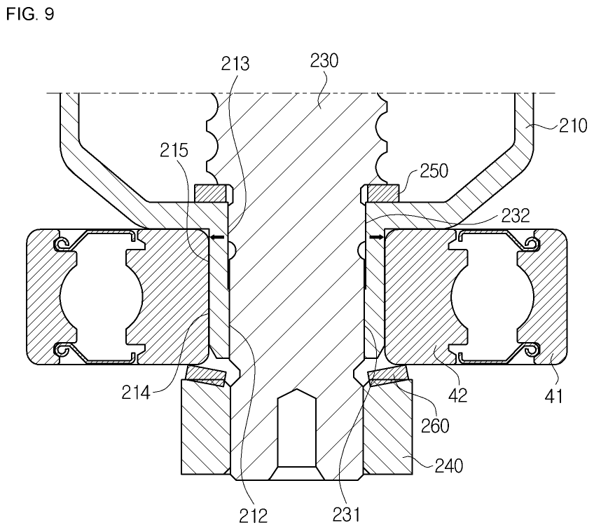

FIG. 8 is a schematic cross-sectional view illustrating one end portion of a screw shaft of a rotor according to another embodiment, and FIG. 9 is a schematic cross-sectional view illustrating a coupling structure of the rotor and a bearing of a motor according to another embodiment.

Referring to FIGS. 8 and 9, in another embodiment of the present disclosure, an axial length of an alignment part 231 provided on one end portion 230a of a screw shaft 230 may be greater than an axial length of a coupling part 232. In FIG. 8, an example in which the axial length of the alignment part 231 is about twice the axial length of the coupling part 232 is illustrated.

In a case in which the length of the alignment part 231 is increased in this way, when the one end portion 230a of the screw shaft 230 is coupled to a hollow shaft 210 from the inside to the outside thereof, an area in which the alignment part 231 is in contact with a small diameter portion 212 of the hollow shaft 210 increases and the axial length of the coupling part 232 decreases, and thus a moving distance of the screw shaft 230 from when the alignment part 231 is coupled to the small diameter portion 212 to when the coupling part 232 is coupled to a large diameter portion 213 may increase. Since a contact area of the alignment part 231 and the small diameter portion 212 increases and the moving distance of the screw shaft 230 increases in this way, the axial alignment of the screw shaft 230 due to the alignment part 231 may be more precise and thus the concentricity of the screw shaft 230 may be increased.

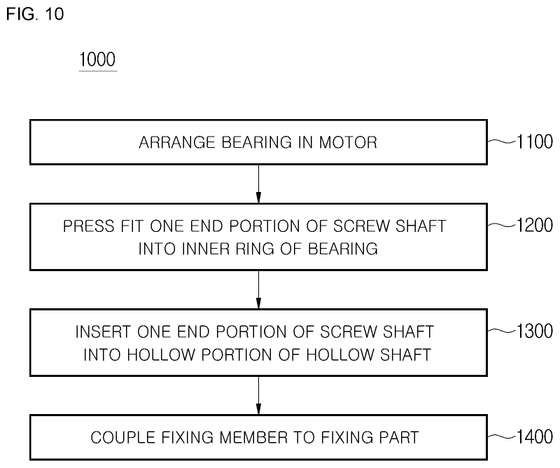

FIG. 10 is a schematic flowchart illustrating a method of manufacturing the motor according to the present embodiment.

Referring to FIG. 10, the method of manufacturing the motor 1 described with reference to the embodiments of the present disclosure can be seen.

Referring to FIG. 10, in a method 1000 of manufacturing the motor 1 according to the present embodiment, first, the bearing 40 is disposed in the motor 1 (1100).

Then, the one end portion 210a of the hollow shaft 210 having a tubular shape is press-fitted into the inner ring 42 of the bearing 40 (1200).

The one end portion 210a of the hollow shaft 210 according to the present embodiment may have a diameter smaller than that of the body 210b coupled to the magnets 220 to be coupled to the inner ring 42 of the bearing 40. The one end portion 210a of the hollow shaft 210 may be press-fitted into the inner ring 42 of the bearing 40 so that the rotor 200 of the motor 1 is supported by the bearing 40.

Then, the one end portion 230a of the screw shaft 230 is inserted into the hollow portion 211 provided in the one end portion 210a of the hollow shaft 210 (1300).

The screw shaft 230 may be coupled to the hollow shaft 210 and rotate along with the hollow shaft 210. The one end portion 230a of the screw shaft 230 may be coupled to the one end portion 210a of the hollow shaft 210 so that the screw shaft 230 rotates along with the hollow shaft 210, and a ball nut may be disposed between and coupled to the screw shaft 230 and the hollow shaft 210 in the radial direction of rotation and moved forward and backward according to rotation of the screw shaft 230.

In this case, the inserting of the one end portion 230a of the screw shaft 230 into the hollow portion 211 may include inserting the alignment part 231 provided on one end portion of the screw shaft 230 into the hollow portion 211 and inserting the coupling part 232 provided on the one end portion of the screw shaft into the hollow portion 211.

As described above, the alignment part 231 and the coupling part 232 may be provided on the one end portion 230a of the screw shaft 230, and the alignment part 231 may be provided closer to an end portion side than the coupling part 232. Accordingly, in the present embodiment, as the one end portion 230a of the screw shaft 230 in inserted into the hollow portion 211 of the hollow shaft 210 in the direction from the inside toward the outside of the hollow shaft 210, the alignment part 231 and the coupling part 232 may be sequentially inserted thereinto.

In this case, the inserting of the alignment part 231 into the hollow portion 211 may include slidably coupling the alignment part 231 into the hollow portion 211. As the alignment part 231 may come into contact with the inner side of the hollow portion 211, more preferably, with the inner circumferential surface of the small diameter portion 212 of the hollow portion 211 and slidably coupled thereto, the axial direction of the screw shaft 230 may be aligned.

Alternatively, in another embodiment, inserting of an alignment part 231 into a hollow portion 211 may include press-fitting the alignment part 231 into the hollow portion 211. As the alignment part 231 may be press-fitted into the hollow portion 211, more preferably, to an inner circumferential surface of a small diameter portion 212 of the hollow portion 211, an axial direction of a screw shaft 230 may be aligned

In the present embodiment, the alignment part 231 may come into contact with the small diameter portion 212 inside the hollow portion 211 so that the axial direction of the screw shaft 230 is aligned with the axial direction of the hollow shaft 210, and then the coupling part 232 may come into contact with the large diameter portion 213 inside the hollow portion 211 so that the screw shaft 230 may be coupled to the hollow shaft 210 without slipping.

Then, the fixing member 240 is coupled to the fixing part 233 protruding through the hollow portion 211 and the inner ring 42 of the bearing 40 (1400).

According to a motor and a method of manufacturing the same according to the present embodiment, the concentricity between a hollow shaft and a screw shaft can be increased in the hollow type motor.

According to a motor and a method of manufacturing the same according to the present embodiment, concentricity can be increased while preventing slippage between a hollow shaft and a screw shaft using a simple structure.

What is claimed is:

1. A motor including a stator and a rotor disposed to be spaced apart from an inner circumferential surface of the stator, wherein:
the rotor includes a hollow shaft having a tubular shape and one end portion press-fitted into an inner ring of a bearing fixedly disposed in the motor and a screw shaft having one end portion inserted into a hollow portion provided in the one end portion of the hollow shaft; and
an alignment part for axial alignment with the hollow shaft and a coupling part for preventing slipping on the hollow shaft are provided on the one end portion of the screw shaft.

2. The motor of claim 1, wherein the alignment part is slidably coupled to the hollow portion of the hollow shaft.

3. The motor of claim 1, wherein the alignment part is press-fitted into the hollow portion of the hollow shaft.

4. The motor of claim 1, wherein the coupling part is knurled and coupled to the hollow shaft.

5. The motor of claim 1, wherein the alignment part is located closer to an end portion than the coupling part.

6. The motor of claim 5, wherein an outer diameter of the alignment part is smaller than an outer diameter of the coupling part.

7. The motor of claim 6, wherein a fixing part protruding through the hollow portion and the inner ring of the bearing and coupled to a fixing member configured to prevent the screw shaft from being separated from the bearing is provided on the one end portion of the screw shaft.

8. The motor of claim 7, wherein an outer diameter of the fixing part is smaller than the outer diameter of the alignment part.

9. The motor of claim 5, wherein the hollow portion includes:
a small diameter portion in contact with the alignment part; and
a large diameter portion having an inner diameter greater than an inner diameter of the small diameter portion and coupled to the coupling part,
wherein the small diameter portion is located closer to the end portion than the large diameter portion.

10. The motor of claim 9, wherein an inner diameter of the large diameter portion is smaller than an outer diameter of the coupling part.

11. The motor of claim 10, wherein, in the one end portion of the hollow shaft, an outer diameter of an outer circumferential surface of a portion coupled to the coupling part is smaller than an outer diameter of an outer circumferential surface of a portion coupled to the alignment part.

12. The motor of claim 9, wherein a distance from a lower end portion of the alignment part to a lower end portion of the coupling part is greater than an axial length of the large diameter portion.

13. The motor of claim 1, wherein at least one keyway is provided in the one end portion of the hollow shaft.

14. The motor of claim 1, wherein a concave portion recessed toward a rotation axis along an outer circumferential surface of the screw shaft is provided between the alignment part and the coupling part.

15. The motor of claim 1, wherein the hollow shaft is made of a material whose hardness is lower than that of the bearing.

16. The motor of claim 1, wherein an axial length of the alignment part is greater than an axial length of the coupling part.

17. A method of manufacturing a motor including a stator and a rotor disposed to be spaced apart from an inner circumferential surface of the stator, the method including:
arranging a bearing in the motor;
press-fitting one end portion of a hollow shaft having a tubular shape into an inner ring of the bearing; and
inserting one end portion of a screw shaft into a hollow portion provided in the one end portion of the hollow shaft,
wherein the inserting of the one end portion of the screw shaft includes inserting an alignment part provided on the one end portion of the screw shaft for axial alignment with the hollow shaft into the hollow portion and inserting a coupling part provided on the one end portion of the screw shaft for preventing slipping on the hollow shaft into the hollow portion.

18. The method of claim 17, wherein the inserting of the alignment part includes slidably coupling the alignment part into the hollow portion.

19. The method of claim 17, wherein the inserting of the alignment part includes press-fitting the alignment part into the hollow portion.

20. The method of claim 17, further comprising coupling a fixing member configured to prevent the screw shaft from being separated from the bearing to a fixing part protruding through the hollow portion and the inner ring of the bearing.
